(19) United States
(12) Patent Application Publication
(10) Pub. No.: US 2006/0198479 A1
(43) Pub. Date: Sep. 7, 2006

(54) DATA SYNCHRONIZER SYSTEM

(76) Inventors: Hung-Yuan Hsu, Hsin-Chu Hsien (TW); Ching-Lin Chung, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/906,677

(22) Filed: Mar. 1, 2005

(51) Int. Cl. H04L 7/00

(52) U.S. Cl. 375/354

(57) ABSTRACT

A data synchronizer system includes at least two synchronizers for receiving a source pulse signal, a corresponding source clock, and a destination clock. At least two first memory units each have a destination clock input. A first switch has an input coupled to the source pulse signal and an output selectively coupled to a source pulse signal input of any one of the synchronizers. A second memory unit has an input coupled to the source data signal and a clock input coupled to the source clock. A second switch has an input coupled to an output of the second memory unit and an output selectively coupled to an input of any one of the first memory units. A generator is coupled to outputs of the synchronizers for outputting a data switch signal. A multiplexer has inputs coupled to outputs of the first memory units and outputs a destination data signal.

### BACKGROUND OF INVENTION

1. Field of the Invention

The present invention relates to digital electronics, and more specifically, to data synchronizers.

2. Description of the Prior Art

Synchronizers are typically used to reduce information loss in systems having more than one clock. Such loss can be in the form of a pulse that is not sampled because its own clock and the sampling clock are too far out of phase. In ideal systems this does not happen since clocks are assumed to have periods that are perfect integer multiples of each other and that are precisely in phase. However in real systems, this problem can occur because clock signals can easily become uncorrelated or skewed by a multitude of reasons including circuit delays, conductor lengths, and interference.

The conventional synchronizer takes as input a source pulse signal and source and destination clock signals that may be out of phase and may have a non-integer relationship of periods. Such a synchronizer compensates for the less-than-ideal relationship of the source and destination clocks and outputs a destination pulse signal that is synchronized with the source pulse signal.

Some state-of-the-art synchronizers are briefly described as follows. U.S. Pat. No. 6,218,874, which is included herein by reference, discloses a one-shot pulse synchronizer. This synchronizer includes an input section of logic, data flip-flops, and a one-shot state machine at the output. U.S. Pat. No. 6,172,538, which is included herein by reference, discloses a universal pulse synchronizer that employs counters and a comparator.

One application of synchronizers is the transfer of data between circuits of different clock domains. A conventional way to do this is to use a first-in-first-out (FIFO) buffer 102 as shown in FIG. 1. Data can be input into the FIFO buffer 102 by way of a write pointer circuit 104 that is clocked by a source clock SCLK. Data can be read from the FIFO buffer 102 by way of a read pointer circuit 106 that is clocked by a destination clock DCLK. The write pointer circuit 104 and the read pointer circuit 106 are connected with each other to achieve synchronization.

Such a synchronization circuit is disclosed in U.S. Pat. No. 6,055,285, which is included herein by reference. This art discloses a synchronization circuit for transferring pointer values between two asynchronous circuits.

Although there are a wide variety of data synchronizers available, ever increasing data transmission rates and intricate communications schemes require a data synchronizer system that can better handle clock or signal irregularities. Such a data synchronizer system would reduce errors associated with lost data.

### SUMMARY OF INVENTION

It is therefore a primary objective of the invention to provide a data synchronizer system and related method of synchronizing data to solve the above problems.

Briefly summarized, an embodiment of the invention includes at least two synchronizers for receiving a source pulse signal, a corresponding source clock, and a destination clock; at least two first memory units each having a destination clock input; a first switch having an input coupled to the source pulse signal and an output selectively coupled to a source pulse signal input of any one of the synchronizers; a second memory unit having an input coupled to the source data signal and a clock input coupled to the source clock; a second switch having an input coupled to an output of the second memory unit and an output selectively coupled to an input of any one of the first memory units for coupling the output of the second memory unit to a selected first memory unit; a generator, coupled to an output of each synchronizer, for outputting a data switch signal; and a multiplexer having inputs coupled to outputs of the first memory units and an output for outputting a destination data signal based on the data switch signal from the generator.

It is an advantage of the invention that the first and second switches divide the source pulse and data signals among synchronizers and first memory units so that these signals are more readily synchronized.

It is an advantage of the invention that pulses of the source signals can be more closely spaced without affecting the expected synchronized destination data signal.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a conventional FIFO-based data synchronizer.

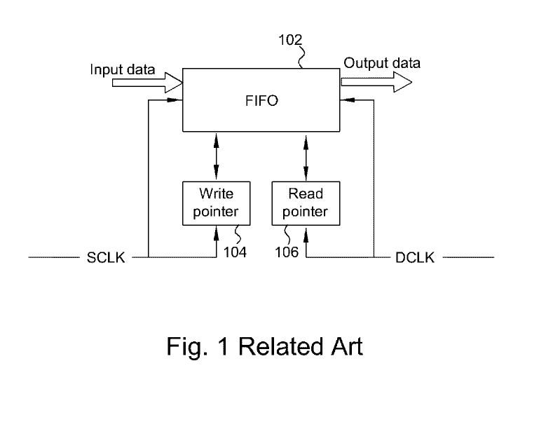

FIG. 2 is a block diagram of a general data synchronizer system according to the invention.

FIG. 3 is a block diagram of one embodiment of the piped synchronizer of FIG. 2.

FIG. 4 is a schematic diagram of an embodiment of the synchronizer unit of FIG. 3.

FIG. 5 is a schematic diagram of one embodiment of the synchronizer of FIG. 4.

FIG. 6 is a block diagram of a two-pipe data synchronizer system according to the invention.

FIG. 7 is a waveform diagram of examples of signals in the two-pipe data synchronizer system of FIG. 6.

FIG. 8 is a block diagram of another embodiment of a two-pipe data synchronizer system according to the invention.

FIG. 9 is a block diagram of an N-pipe data synchronizer system according to the invention.

FIG. 10 is a block diagram of an application for the data synchronizer system according to the invention.

FIG. 11 is a block diagram of another application for the data synchronizer system according to the invention.

### DETAILED DESCRIPTION

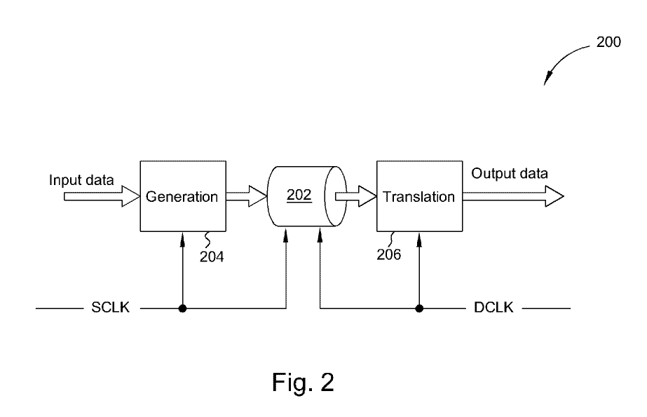

Please refer for FIG. 2 which illustrates a block diagram of a data synchronizer system 200 according to the invention. The data synchronizer system 200 includes a piped synchronizer 202, a generation circuit 204, and a translation circuit 206. The piped synchronizer 202 includes a plurality of synchronizers each for handling a part of data input into the data synchronizer system 200. The generation circuit 204 sends a part of the input data to a synchronizer of the piped synchronizer 202, and the translation circuit 206 assembles the output of the piped synchronizer 202 into the expected output data. Generally, the generation circuit 204 operates according to a source clock SCLK, the translation circuit operates according to a destination clock DCLK (the clocks SCLK and DCLK defining two clock domains), and the piped synchronizer 202 operates according to both clocks SCLK, DCLK.

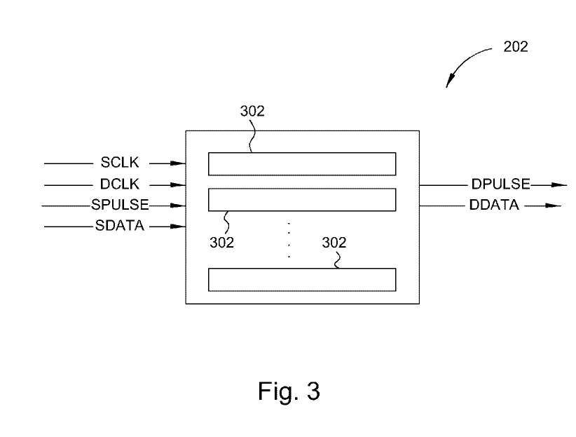

Please refer to FIG. 3 which illustrates one embodiment of the piped synchronizer 202 according to the invention. The piped synchronizer 202 includes a plurality of synchronizer units 302. Input to the piped synchronizer 202 includes the source clock SCLK, the destination clock DCLK, a source pulse signal (sometimes called a source strobe signal) SPULSE, and a source data signal SDATA. Output of the piped synchronizer 202 includes a destination pulse signal (sometimes called a destination strobe signal) DPULSE and a destination data signal DDATA.

The clock signals SCLK and DCLK are from the two clock domains. Generally, clock signals SCLK and DCLK will come from different circuits and/or clock generators. The source and destination pulse signals SPULSE, DPULSE are strobe signals that indicated that valid data is presently in the respective data signal SDATA, DDATA. That is, when the source signal SPULSE is high, data in the signal SDATA can be sampled, for example. Likewise, when the destination signal DPULSE is high, data in the signal DDATA can be sampled, for example. Naturally the logic could be reversed and low levels could be used instead. The data signals SDATA and DDATA are usually simple binary signals that represent digital data by high and low levels (e.g. high=1, low=0), however more complicated data schemes are also common. Data of the signals SDATA and DDATA can be grouped as represented by [0:15] for 16 bits, for example.

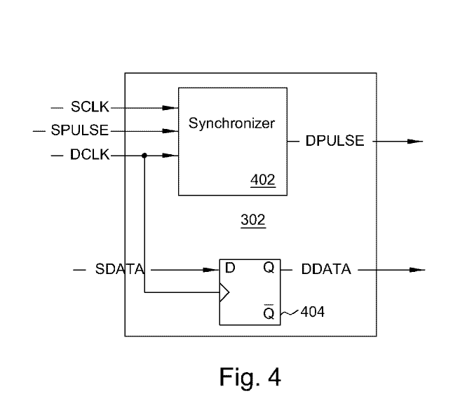

FIG. 4 illustrates a schematic diagram of an embodiment of the synchronizer unit 302 according to the invention. The synchronizer unit 302 includes a synchronizer 402 and a memory unit 404, which can be a device such as a D-type flip-flop or similar device. The source clock signal SCLK and the source pulse signal SPULSE are input into the synchronizer 402. The destination clock signal DCLK is input into the synchronizer 402 and also into the clock input of the memory unit 404. The memory unit 404 receives the source data signal SDATA at a data input terminal D and outputs the DDATA signal at an output terminal Q. Generally, the synchronizer 402 can be of any well-known design.

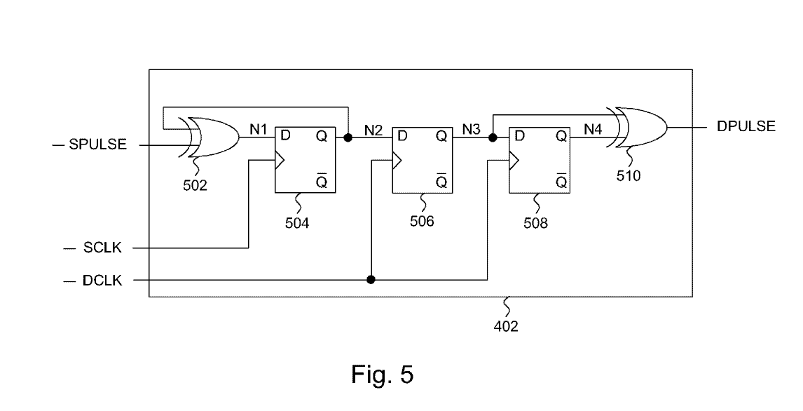

FIG. 5 is a schematic diagram of one embodiment of the synchronizer 402 according to the invention. The synchronizer 402 includes a first exclusive-or logic (i.e. a XOR gate) 502 having an output connected to an input of a memory unit (i.e. a D-type flip-flop) 504. The memory 504 unit has an output connected to an input of the first exclusive- or logic 502 and to an input of a memory unit 506. The memory unit 506 has an output connected to an input of a memory unit 508 and to an input of a second exclusive-or logic 510. The memory unit 508 has an output connected to another input of the second exclusive-or logic 510. The synchronizer 402 can be provided on a single silicon chip or can be provided as discrete digital devices.

The exclusive-or logics 502, 510 can each be implemented by any logic circuit or combination of logic gates that results in the truth table of the logical exclusive-or operation. One solution is to use a XOR gate. In other embodiments, the exclusive-or logic can be the well-known combination of two AND gates, two inverters, and an OR gate or can be the equally well-known combination of four NAND gates.

The memory units 504, 506, 508 can each be implemented by a simple memory device, delay circuit, or flip-flop that stores the value (high or low, binary 1 or 0) provided at the input for output during a next clock cycle (i.e. period). One solution is to use a D-type flip-flop. In other embodiments, SR-type flip-flops and/or JK-type flip-flops can be used. Moreover, the memory units 504, 506, 508 need not be identical.

The source signal SPULSE is applied to another input of the first exclusive-or logic 502. The source clock SCLK is applied to the clock input of the memory unit 504. The destination clock DCLK is applied to the clock inputs of the memory units 506, 508. The destination signal DPULSE is taken from the output of the second exclusive-or logic 510.

The synchronizer 402 can operate according to two frequency modes. In a low-to-high (L2H) mode, the frequency of the source clock SCLK is less than the frequency of the destination clock DCLK. In a high-to-low (H2L) mode, the frequency of the source clock SCLK is greater than or equal to the frequency of the destination clock DCLK. It should be noted that these modes are simply dependant on what clock frequencies are inputted. For the synchronizer 402, a minimum allowable number of cycles of the source clock SCLK between two one-shot pulses can be expressed as

$${n}_{1} \geq \frac{{f}_{SCLK}}{{f}_{DCLK}} = K , \qquad ( 1 )$$

wherein

n₁ is a positive integer, and represents the minimum allowable number of source clock SCLK cycles that can occur between two pulses of the source signal SPULSE;

K is the frequency ratio;

f_{SCLK} is the frequency of the source clock SCLK; and

f_{DCLK} is the frequency of the destination clock DCLK;

assuming that the cycle lengths of the clocks SCLK, DCLK are ideal.

Note that when f_{SCLK} is less than f_{DCLK}, i.e. K<1, the obtained n₁ can be 1, 2, 3, or any other positive integer. This means that the synchronizer 402 is safe for the L2H mode when the source signal SPULSE is coming continuously.

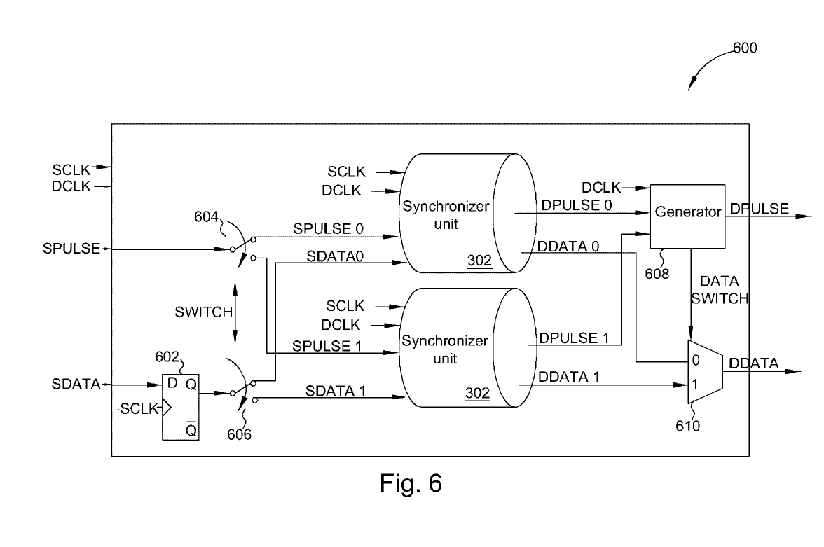

Please refer to FIG. 6 which illustrates a block diagram of a two-pipe data synchronizer system 600 according to the invention. The two-pipe data synchronizer system 600 includes two synchronizer units 302 (a first shown above a second), a memory unit 602, two switches 604 and 606 (a first shown above a second), a generator 608, and a multiplexer (or switch) 610. In other embodiments, the two-pipe data synchronizer system 600 can employ other kinds of synchronizer units, such as those that use well-known synchronizers, without reducing benefits.

The memory unit 602 is a D-type flip-flop or similar device. A data input D of the memory unit 602 is connected to the source data signal SDATA. An output Q of the memory unit 602 is connected to the input of the switch 606. A clock input of the memory unit 602 is connected to the source clock SCLK.

The switches 604 and 606 direct the source strobe signal SPULSE and the source data signal SDATA, respectively, to the synchronizer units 302 in a synchronized manner. The switches 604 and 606 can be a multiplexer(s) or other logic circuits of similar function. The synchronized manner of directing the source strobe signal SPULSE and the source data signal SDATA to the same synchronizer unit 302 can be achieved by driving the switches 604 and 606 by the same signal. The switches 604 and 606 can also be combined into a single device, as defined by specific design requirements.

Each synchronizer unit 302 receives both clocks SCLK and DCLK. A strobe input of each synchronizer unit 302 is connected to the switch 604 such that the switch 604 controls the delivery of the source strobe signal SPULSE; in one position, the switch 604 delivers the source signal SPULSE to the first synchronizer unit 302 as a sub-signal SPULSE0, and in the other position the switch 604 delivers the source signal SPULSE to the second synchronizer unit 302 as a sub-signal SPULSE1. A data input of each synchronizer unit 302 is connected to the switch 606 such that the switch 606 controls the delivery of the source data signal SDATA; in one position, the switch 606 delivers the source data signal SDATA to the first synchronizer unit 302 as a sub-signal SDATA0, and in the other position the switch 606 delivers the source data signal SDATA to the second synchronizer unit 302 as a sub-signal SDATA1. The switches 604, 606 can be driven synchronously by the same input signal SWITCH, so that only one synchronizer unit 302 receives both the SPULSE and SDATA signals. The first synchronizer unit 302 outputs a destination strobe sub-signal DPULSE0 and a destination data sub-signal DDATA0. The second synchronizer unit 302 outputs a destination strobe sub-signal DPULSE1 and a destination data sub-signal DDATA1.

The generator 608 has inputs connected to the synchronizer units 302 that receive the destination strobe sub-signals DPULSE0, DPULSE1. The generator 608 also has a clock input that receives the destination clock DCLK. The generator 608 outputs a selection signal DATASWITCH to the multiplexer 610 and also outputs the expected destination strobe signal DPULSE. Preferably, the generator 608 comprises an up-down counter. Generally, the selection signal DATASWITCH is toggled (i.e. 0 becomes 1, 1 becomes 0) when a cumulative sum value C2 of the up-down counter is greater than zero. This can be implemented by a simple AND gate (or equivalent) connected between the output C2 of the generator 608 and a constant high level signal. The outputs of up-down counter of the generator 608 and the generation of the selection signal DATASWITCH are explained in more detail below.

The multiplexer 610 has inputs connected to destination data sub-signals DDATA0, DDATA1 output by the respective synchronizer unit 302. The multiplexer 610 can also be a switch similar to the switches 604, 606. The multiplexer 610 has a selection input connected to the selection signal DATASWITCH output by the generator 608. According to the signal DATASWITCH on the selection input, the multiplexer 610 outputs either the data sub-signal DDATA0 or the data sub-signal DDATA1 as the destination data signal DDATA. When the selection input is low (i.e. 0), the multiplexer 610 outputs the sub-signal DDATA0 on its “0” input, and when the selection input is high (i.e. 1), the multiplexer 610 outputs the sub-signal DDATA1 on its “1” input.

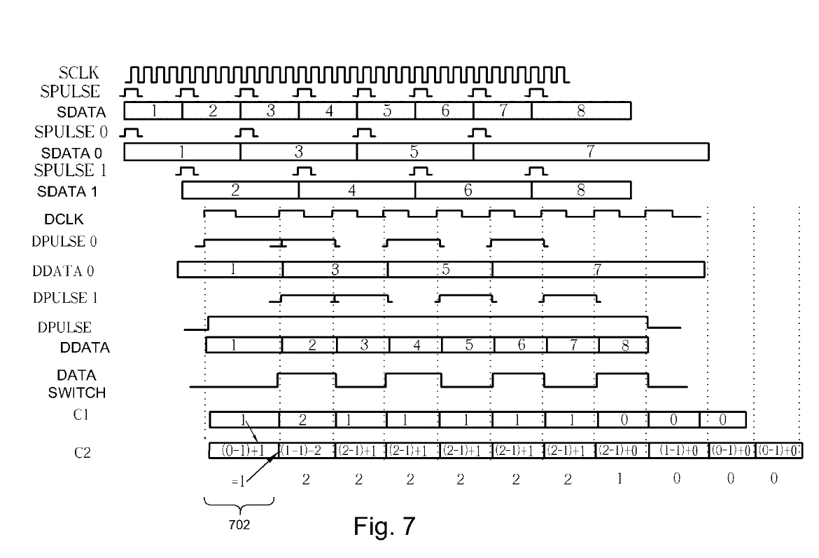

FIG. 7 illustrates waveform diagrams of examples of signals in the two-pipe data synchronizer system 600. This example illustrates the basic working principle of the two-pipe data synchronizer system 600, and more particularly, how the invention handles a poor destination clock. When the switches 604, 606 are switched with each period of the destination clock DCLK, the source sub-signals SPULSE0 and SPULSE1 each have alternate pulses of the source signal SPULSE signal. It should be mentioned that, in another example, if the source signal SPULSE lacked a pulse in a certain region, a sub-signal would also lack a pulse there. According to the source sub-signals SPULSE0 and SPULSE1, the destination sub-signals DPULSE0 and DPULSE1 have values as expected, except in a cycle 702 which is unexpectedly long. Because of this cycle 702, the first high level of the sub-signal DPULSE0 is too long, and the levels of the second generated pulses of DPULSE0 and DPULSE1 are the same as the levels of the first generated pulses of DPULSE0 and DPULSE1.

Continuing with the example, the data signals in FIG. 7 are numbered to indicate bit numbers of the source data signal SDATA. The numbering used is for convenience of explanation only. It can be seen that because of the memory unit 602, the source data sub-signals SDATA0, SDATA1 each have a length that is two periods of the destination clock DCLK. The sub-signals SDATA0, SDATA1 also overlap by one period of the destination clock DCLK. The destination data sub-signals DDATA0, DDATA1 have values as expected, except that the first data element (bit number=2) of the sub-signal DDATA1 is shorter than expected because of the unexpectedly long cycle 702. Despite the long cycle 702, the two-pipe data synchronizer system 600 outputs the correct destination data signal DDATA as explained in the following.

Referring to generator signals C1 and C2 in FIG. 7, the value of C1 is simply a sum of the binary values (high=1, low=0) of the sub-signals DPULSE0 and DPULSE1, and the value C2 is a cumulative sum of previous values C1 reduced by 1 each cycle of the destination clock DCLK. Note that for the special case of the first cycle of signal C2, if the value in parenthesis is less than zero it is regarded as zero, i.e. (0-1) becomes 0. As can be seen, the generator 608 outputs a high level for the destination signal DPULSE whenever the value C2 is greater than 0. So, despite the unexpectedly long cycle 702, two-pipe data synchronizer system 600 still generates the expected destination signal DPULSE. Of equal importance, since the generator 608 toggles the selection signal DATASWITCH of the multiplexer 610 when the value C2 is greater than zero, the destination data signal DDATA is also as expected despite the long cycle 702.

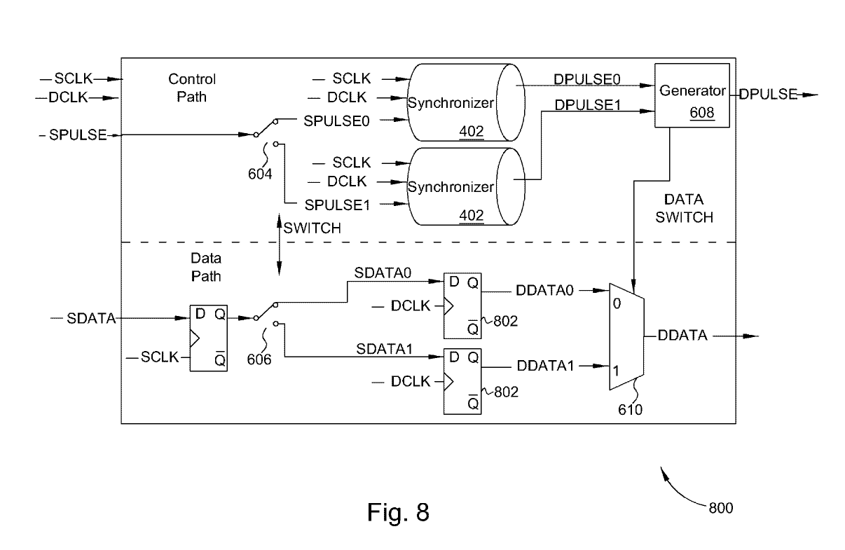

FIG. 8 illustrates another embodiment of a two-pipe data synchronizer system according to the invention. A two-pipe data synchronizer system 800 includes similar components to the two-pipe data synchronizer system 600 of FIG. 6, with like elements having like reference numerals. The components can be divided into a control path and a data path, which are separated by a dashed line in FIG. 8. One difference between the two-pipe data synchronizer systems 800 and 600 is that the two-pipe data synchronizer system 800 includes synchronizers 402 rather than synchronizer units 302. The synchronizers 402 are in the control path. This means that memory units 802 in the data path are provided to account for the memory units 404 of the synchronizer units 302 that are no longer provided. The two-pipe data synchronizer system 800 operates in substantially the same way as the two-pipe data synchronizer system 600.

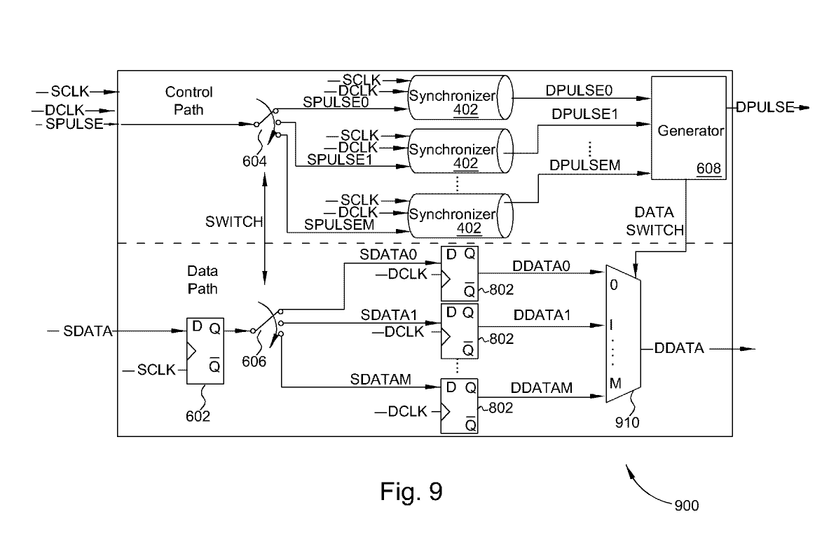

FIG. 9 is a block diagram of an N-pipe data synchronizer system according to the invention. The N-pipe data synchronizer system 900 includes similar components to the two-pipe data synchronizer system 800 of FIG. 8, with like elements having like reference numerals. The signals are also similar except for the N-th sub-signals such as the source pulse sub-signal SPULSEM (where M=N−1), destination pulse sub-signal DPULSEM, source data sub-signal SDATAM, and destination data sub-signal DDATAM. The components are also divided into a control path and a data path, which are separated by a dashed line in FIG. 9. An N-input multiplexer 910 is also provided which requires that the selection signal DATASWITCH be cycled through selection values rather than simply being toggled as in the two-pipe data synchronizer systems 600, 800. This requires the generator 608 to have suitable logic, a lookup table, or similar to produce the selection signal DATASWITCH when the value C2 is greater than zero. A key constraint is that the data sub-signals DDATA0-DDATAM must be cyclically selected according to the selected synchronizer 402 and memory unit 802 to produce the expected destination data signal DDATA. Other than these differences, the N-pipe data synchronizer system 900 operates in substantially the same way as the two-pipe data synchronizer system 800.

For the piped data synchronizer systems 600, 800, 900, when the number of synchronizers 402 or synchronizer units 302 employed is N, the minimum allowable number of source clock SCLK cycles that can occur between two pulses of the source signal SPULSE can be expressed as

$${n}_{N} > \frac{1}{N} \frac{{f}_{SCLK}}{{f}_{DCLK}} , where K = \frac{{f}_{SCLK}}{{f}_{DCLK}} , \qquad ( 2 )$$

which is clearly 1/N that of a single synchronizer alone. Note that n_{N} is a positive integer. For example, with a frequency ratio, K, of 4, n_{N}>2, which means the minimum space between adjacent one-shot pulses can be reduced to three cycles of the source clock SCLK. Therefore, the piped data synchronizer systems 600, 800, 900 according to the invention have improved tolerances to signal irregularity. In fact, with a frequency ratio, K, of 4, the source clock SCLK can actually be tolerated to be up to eight times than that of the destination clock DCLK.

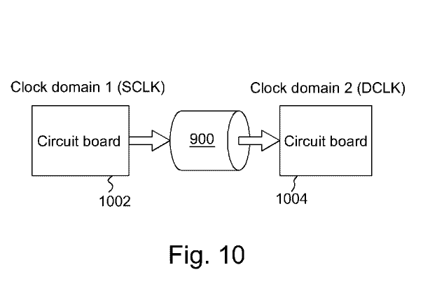

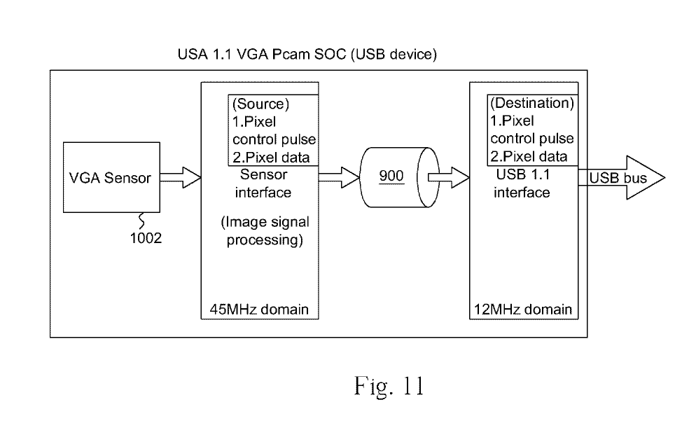

FIG. 10 is a block diagram of an application for a data synchronizer system according to the invention. In FIG. 10, two circuit boards 1002, 1004 are connected by the N-pipe data synchronizer system 900. FIG. 11 illustrates an application of the invention, namely a universal serial bus (USB) 1.1 PC Camera that can be a system-on-chip (SOC) device having a connection between a sensor interface and a USB 1.1 interface. In this case the source clock SCLK would be about 48 MHz at the sensor interface allowing the camera to provide 30 frames per second (FPS), the destination clock DCLK would be about 12 MHz at the USB 1.1 interface, and so the frequency ratio, K, would be 4 as in previous examples. The USB 1.1 PC Camera application is specifically suitable for the two-pipe data synchronizer systems 600 and 800.

In contrast to the prior art, the invention provides improved handling of clock or pulse/strobe signal irregularities. This is achieved by the switches dividing the source pulse and data signals among several synchronizers and memory units, and by the initial memory unit, so that the data signals are more readily synchronized. This is also achieved by the generator selecting the proper data sub-signal to produce the expected destination data signal. Moreover, pulses of the source signals can be more closely spaced without adversely affecting the destination signals.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data synchronizer system comprising:
at least two synchronizers for receiving a source pulse signal, a corresponding source clock, and a destination clock;
at least two first memory units each having a destination clock input;
a first switch having an input coupled to the source pulse signal and an output selectively coupled to a source pulse signal input of any one of the synchronizers;
a second memory unit having an input coupled to the source data signal and a clock input coupled to the source clock;
a second switch having an input coupled to an output of the second memory unit and an output selectively coupled to an input of any one of the first memory units for coupling the output of the second memory unit to a selected first memory unit;
a generator coupled to an output of each synchronizer, for outputting a data switch signal; and
a multiplexer having inputs coupled to outputs of the first memory units, and an output for outputting a destination data signal based on the data switch signal from the generator.

2. The data synchronizer system of claim 1, wherein the first and second switches are linked, such that the synchronizers are uniquely and exclusively paired with the first memory units.

3. The data synchronizer system of claim 2, wherein the first and second switches are part of the same switch.

4. The data synchronizer system of claim 2, wherein the first and second switches are switched by the same signal.

5. The data synchronizer system of claim 1, wherein the generator comprises an up-down counter.

6. The data synchronizer system of claim 5, wherein for a cycle of the destination clock, the up-down counter sums binary values of corresponding levels of outputs of the synchronizers, reduces by one a cumulative value of a previous cycle of the destination clock, and adds the sum to the reduced cumulative value to obtain a cumulative value of a current cycle of the destination clock; and when the current cumulative value of the up-down counter is greater than zero, the data switch signal is cycled between predetermined states each corresponding to an input of the third switch.

7. The data synchronizer system of claim 1, wherein any one of the first and second memory units is a D-type flip-flop.

8. The data synchronizer system of claim 1, wherein the number of synchronizers corresponds to the number of first memory units.

9. The data synchronizer system of claim 1, wherein each synchronizer comprises:
a first exclusive-or logic having a first input coupled an output of the first switch;
a third memory unit having an input coupled to an output of the first exclusive-or logic, a clock input coupled to the source clock, and an output coupled a second input of the first exclusive-or logic;
a fourth memory unit having an input coupled to the output of the third memory unit and a clock input coupled to the destination clock;
a fifth memory unit having an input coupled to an output of the fourth memory unit and a clock input coupled to the destination clock; and
a second exclusive-or logic having a first input coupled to an output of the fifth memory unit, a second input coupled to the output of the fourth memory unit, and an output coupled to the generator.

10. The data synchronizer system of claim 9, wherein the third, fourth, and fifth memory units are D-type flip-flops.

11. The data synchronizer system of claim 9, wherein the first and second exclusive-or logics are XOR gates.

12. A method for synchronizing data signals, comprising:
receiving a source pulse signal;
receiving a source data signal;
separating the source pulse signal into at least two source pulse sub-signals by cycling through the source pulse sub-signals according to a cycle of a destination clock, and providing the cycled source pulse sub-signal with a corresponding level of the source pulse signal and providing the remaining source pulse sub-signals with predetermined levels;
delaying the source data signal by one cycle of a source clock;
separating the source data signal into at least two source data sub-signals by cycling through the source data sub-signals according to two cycles of the destination clock, and providing the cycled source data sub-signal with a corresponding level of the source data signal;
delaying the source data sub-signals by one cycle of the destination clock to produce at least two destination data sub-signals; and
outputting a selected destination data sub-signal as a destination data signal.

13. The method of claim 12, further comprising:
for each source pulse sub-signal, according to the source clock producing a destination pulse sub-signal that is synchronized with the destination clock;
for a cycle of the destination clock, summing binary values of corresponding levels of the destination sub-signals, reducing by one a cumulative value of a previous cycle of the destination clock, and adding the sum to the reduced cumulative value to obtain a cumulative value of a current cycle of the destination clock; and
cyclically selecting a destination data sub-signal as the destination data signal when the current cumulative value is greater than zero.

14. The method of claim 13, further comprising merging the synchronized destination pulse sub-signals into a destination pulse signal according to the current cumulative value.

15. A method for synchronizing data signals, comprising:
receiving a source pulse signal;
receiving a source data signal;
a step for separating the source pulse signal into at least two source pulse sub-signals;
delaying the source data signal by one cycle of a source clock;
a step for separating the source data signal into at least two source data sub-signals;
delaying the source data sub-signals by one cycle of the destination clock to produce at least two destination data sub-signals;
a step for selecting a destination data sub-signal as a destination data signal; and
outputting the destination data signal.
